(19) United States
(12) Patent Application Publication
(10) Pub. No.: US 2024/0328496 A1
(43) Pub. Date: Oct. 3, 2024

(54) HMT STRUCTURE AND HST UNIT

(71) Applicant: KANZAKI KOKYUKOKI MFG. CO., LTD., Amagasaki-shi (JP)

(72) Inventors: Koji IWAKI, Amagasaki-shi (JP); Tomoyuki TSUJI, Amagasaki-shi (JP); Ryo MOTOOKA, Amagasaki-shi (JP); Terunobu YOSHIOKA, Amagasaki-shi (JP); Kazuhiro OWADA, Amagasaki-shi (JP)

(21) Appl. No.: 18/619,315

(22) Filed: Mar. 28, 2024

(30) Foreign Application Priority Data
Mar. 31, 2023 (JP) 2023-058124

(51) Int. Cl. F16H 47/04; B60K 17/10

(52) U.S. Cl. CPC F16H 47/04; B60K 17/10; B60Y 2200/221; B60Y 2200/222

(57) ABSTRACT

[Problem] To reduce a length in an axial direction of an entire structure including an input gear train for shifting and transmitting an input power to a pump shaft and an output gear train for shifting and transmitting an HST output from a motor shaft to a planetary gear mechanism. [Solution] An HMT structure of the present invention includes an input shaft disposed in parallel to a pump shaft and a motor shaft with one side in an axial direction operatively connected to a drive source and the other side in the axial direction extending from an HST pump to the other side in the axial direction, an HST-input gear train for operatively transmitting a rotational power from the input shaft to the pump shaft, and an HST-output gear train for operatively transmitting an HST output from the motor shaft to a planetary gear mechanism, and the HST-input gear train and the HST-output gear train are disposed between the HST pump and the HST motor, and the planetary gear mechanism in the axial direction.

### CROSS REFERENCE TO RELATED APPLICATIONS

The present invention claims priority under 35 U.S.C. § 119 to Japanese Application, 2023-058124, filed on Mar. 31, 2023, the entire contents of which being incorporated herein by reference.

### TECHNICAL FIELD

The present invention relates to a hydrostatic/mechanical continuously variable transmission structure (HMT structure) having a hydrostatic continuously variable transmission mechanism (HST) and a planetary gear mechanism, and an HST unit including the HST.

### BACKGROUND ART

The HMT structure constituted by combining the HST and the planetary gear mechanism can expand a continuously variable speed-shift width (speed-shiftable range) and is suitably used for a traveling-system transmission path of a work vehicle such as a combine harvester or a tractor.

The HST is configured to continuously varying a rotational power operatively transmitted from a drive source such as an internal combustion engine to a pump shaft and to output it from a motor shaft as an HST output.

The planetary gear mechanism is configured to input the rotational power operatively transmitted from the drive source to any one of three planetary elements, to input the HST output operatively transmitted from the motor shaft of the HST to another of the three planetary elements, to synthesize the inputted rotational power, and to output the synthesized rotational power from the remaining one planetary element.

In an internal combustion engine such as a diesel engine mounted on a work vehicle such as a combine harvester or a tractor, the rotational speed (output rotational speed) of the rotational power is lower than the rotational speed (allowable rotational speed) of the rotational power that can be inputted by the HST in many cases.

In such a case, if the rotational power of the drive source is inputted to the pump shaft of the HST at the same rotational speed, a performance (potential) of the HST cannot be sufficiently exerted, which is disadvantageous.

In consideration of this point, the present applicant has proposed an HMT structure having an HST and a planetary gear mechanism, the HMT structure including an HST-input gear train that increases the speed of a rotational power from a drive source and transmits the rotational power to the pump shaft of the HST (see Patent Documents 1 and 2 below).

The HMT structures described in Patent Documents 1 and 2 (hereinafter, referred to as conventional structures) set a speed increasing ratio of the HST-input gear train so that the rotational speed of the rotational power inputted to the pump shaft of the HST matches a performance of the HST, which is useful in a point that a use state where the performance of the HST is sufficiently exerted can be realized even when the output rotational speed of the drive source is lower than the allowable rotational speed of the HST.

However, the conventional structure has such a problem that a length in an axial direction of the entire HMT structure becomes larger.

That is, in the conventional structure, the HST-input gear train is disposed on one side in the axial direction of the HST (that is, on a side opposite to the planetary gear mechanism with respect to the HST in the axial direction).

Here, in the HMT structure including the conventional structure, an HST-output gear train for operatively transmitting an HST output from a motor shaft of the HST to a corresponding element of the planetary gear mechanism is disposed on the other side in the axial direction of the HST (that is, between the HST and the planetary gear mechanism with respect to the axial direction).

That is, in the conventional structure, the HST-input gear train and the HST-output gear train are disposed on one side and the other side of the HST with respect to the axial direction, and the length in the axial direction of the entire HMT structure including the HST-input gear train, the HST, the HST-output gear train, and the planetary gear mechanism-becomes longer.

### PRIOR ART DOCUMENT

### Patent Document

Patent Document 1: US-A 2020132169
Patent Document 2: US-A 2020124170

### SUMMARY OF INVENTION

### Technical Problem

The present invention was made in view of the aforementioned prior arts and has a first object to provide an HMT structure including an HST for continuously varying an operatively transmitted from a drive source and outputting the same, and a planetary gear mechanism for synthesizing the rotational power operatively transmitted from the drive source and an HST output operatively transmitted from the HST and outputting the same, in which an HST-input gear train for varying the rotational power from the drive source and operatively transmitting the same to a pump shaft of the HST, and an HST-output gear train for varying the HST output from a motor shaft of the HST and operatively transmitting the same to a corresponding element of the planetary gear mechanism are provided, and size reduction with respect to the axial direction can be promoted.

Moreover, a second object of the present invention is to provide an HST unit including the HST, the HST-input gear train for varying the rotational power operatively transmitted from the drive source and for operatively transmitting the same to the pump shaft, and the HST-output gear train for varying the HST output from the motor shaft of the HST, in which the size reduction with respect to the axial direction can be promoted.

### Solution to Problem

In order to achieve the first object, a first aspect of the present invention provides an HMT structure including an HST for continuously varying a rotational power operatively transmitted from a drive source and outputting the same and a planetary gear mechanism for synthesizing the rotational power operatively transmitted from the drive source and an HST output operatively transmitted from the HST and outputting the same, in which an input shaft disposed in parallel to a pump shaft and a motor shaft of the HST and having one side in an axial direction operatively connected to the drive source and the other side in the axial direction extending to the other side in the axial direction from an HST pump of the HST, an HST-input gear train for operatively transmitting a rotational power from the input shaft to the pump shaft, and an HST-output gear train for operatively transmitting an HST output from the motor shaft to the planetary gear mechanism are provided, and the HST-input gear train and the HST-output gear train are disposed between the HST pump and the HST motor, and the planetary gear mechanism with respect to an axial direction.

Preferably, the HST-input gear train and the HST-output gear train are disposed so as to at least partially overlap each other in the axial direction.

In one embodiment, the HMT structure may include an output shaft disposed in parallel to the motor shaft, one side of the output shaft in an axial direction forming an input portion for operatively inputting the HST output from the motor shaft, and the other side in the axial direction forming an output portion for outputting the HST output to the planetary gear mechanism.

In this case, the HST-output gear train operatively is assumed to transmit the HST output from the motor shaft to the output shaft.

In the one embodiment, it is assumed that the HST-input gear train preferably includes an HST-input drive gear supported by the input shaft incapable of relative rotation around an axis, and an HST-input driven gear supported by the pump shaft, incapable of relative rotation around the axis, and meshed with the HST-input drive gear, and the HST-output gear train includes an HST-output drive gear supported by the motor shaft, incapable of relative rotation, and an HST-output driven gear supported by the output shaft, incapable of relative rotation around the axis, and meshed with the HST-output drive gear.

In various configurations of the HMT structure, the HST is configured to include an HST case that houses the HST pump and the HST motor and supports the pump shaft and the motor shaft rotatably around an axis, and the planetary gear mechanism is housed in a transmission case including a TM bearing wall on one side in the axial direction.

In this case, the HST case is configured to be directly or indirectly connected to one side in the axial direction of the transmission case so that a gear housing space is defined between the HST case and the TM bearing wall, and the HST-input gear train and the HST-output gear train are housed in the gear housing space.

The HMT structure may include a connecting cover detachably connected to the HST case and detachably connected to the TM bearing wall so that the gear housing space is defined between the HST case and the TM bearing wall.

In this case, the gear of the HST-input gear train and the gear of the HST-output gear train have the one sides in the axial direction supported by the connecting cover, rotatably around the axis, and the other sides in the axial direction supported by the TM bearing wall, rotatably around the axis.

Further, in order to achieve the second object, a second aspect of the present invention provides an HST unit having an HST for continuously varying a rotational power inputted into a pump shaft and outputting the same from a motor shaft disposed in parallel to the pump shaft, including an input shaft disposed in parallel to the pump shaft and having one side in an axial direction forming an input portion for operatively inputting the rotational power from a drive source and the other side in the axial direction extending to the other side in the axial direction from an HST pump of the HST, an output shaft disposed in parallel to the motor shaft and having one side in the axial direction forming an input portion for operatively inputting an HST output from the motor shaft and the other side in the axial direction forming an output portion, an HST-input gear train for transmitting the rotational power from a part located on the other side in the axial direction from the HST pump in the input shaft to a corresponding part in the axial direction of the pump shaft, an HST-output gear train for transmitting the rotational power from a part located on the other side in the axial direction from an HST motor of the HST in the motor shaft to the input portion of the output shaft, and a housing having an HST housing space for housing the HST pump and the HST motor and a gear housing space for housing the HST-input gear train and the HST-output gear train, in which the input shaft is supported by the housing rotatably around the axis in a state where it extends into the HST housing space and the gear housing space, and one side in the axial direction acting as the input portion is accessible from the one side in the axial direction of the housing and the other side in the axial direction is accessible from the other side in the axial direction of the housing, the pump shaft and the motor shaft are supported by the housing rotatably around the axis in a state where they extend into the HST housing space, and the other sides in the axial direction protrude into the gear housing space, the output shaft is supported by the housing rotatably around the axis in a state where the other side in the axial direction acting as the output portion is accessible from the other side in the axial direction of the housing, and the HST-input gear train and the HST-output gear train are housed in the gear housing space in a state where they overlap each other at least partially with respect to the axial direction.

In one mode of the second aspect, the HST-input gear train may include an HST-input drive gear supported by the input shaft, incapable of relative rotation around the axis, and an HST-input driven gear meshed with the HST-input drive gear in a state of being supported by the pump shaft, incapable of relative rotation around the axis, and the HST-output gear train may include an HST-output drive gear supported by the motor shaft, incapable of relative rotation, and an HST-output driven gear meshed with the HST-output drive gear in a state of being supported by the output shaft, incapable of relative rotation around the axis.

For example, the housing may include an HST case forming the HST housing space, and a gear case forming the gear housing space and detachably connected to the HST case.

In this case, the input shaft is supported by the HST case and the gear case rotatably around the axis in a state where one side in the axial direction extends outward from the HST case and the other side in the axial direction extends outward from the gear case, the pump shaft and the motor shaft are supported by the HST case rotatably around the axis in a state where the other sides in the axial direction protrude into the gear housing space from the HST case, and the output shaft is supported by the gear case rotatably around the axis in a state where the other side in the axial direction acting as the output portion extends outward from the gear case.

### Advantageous Effects of Invention

According to the HMT structure of the present invention, it is possible to reduce the size in the axial direction of the entire HMT structure including the HST, the planetary gear mechanism, the HST-input gear train for varying the rotational power from the drive source and operatively transmitting the same to the pump shaft of the HST and the HST-output gear train for varying the HST output from the motor shaft of the HST and operatively transmitting the same to one corresponding element of the planetary gear mechanism.

Further, according to the HST unit according to the present invention, it is possible to reduce the size in the axial direction of the entire HST unit including the HST, the HST-input gear train for varying the rotational power operatively transmitted from the drive source and for operatively transmitting the same to the pump shaft of the HST, and the HST-output gear train for varying the HST output from the motor shaft of the HST.

### BRIEF DESCRIPTION OF DRAWINGS

FIG. 1 is a schematic diagram of transmission of a work vehicle to which an HMT structure according to a first embodiment of the present invention is applied.

FIG. 2 is a front view of a transmission including the HMT structure.

FIG. 3 is a cross-sectional view taken along a line III-III in FIG. 2.

FIG. 4 is an exploded perspective view of the HST and the transmission in the HMT structure.

FIG. 5 is a cross-sectional view taken along a line V-V in FIG. 3.

FIG. 6 is a cross-sectional view of an HST unit according to a second embodiment of the present invention.

FIG. 7 is a developed cross-sectional view of a transmission to which an HMT structure according to a third embodiment of the present invention is applied.

FIG. 8 is an exploded perspective view of the transmission according to the third embodiment.

FIG. 9 is an enlarged cross-sectional view of an output end portion of an input shaft.

### DESCRIPTION OF EMBODIMENTS

### Embodiment 1

Hereinafter, an embodiment of a hydrostatic/mechanical continuously variable transmission (HMT) structure according to the present invention will be explained with reference to the accompanying drawings.

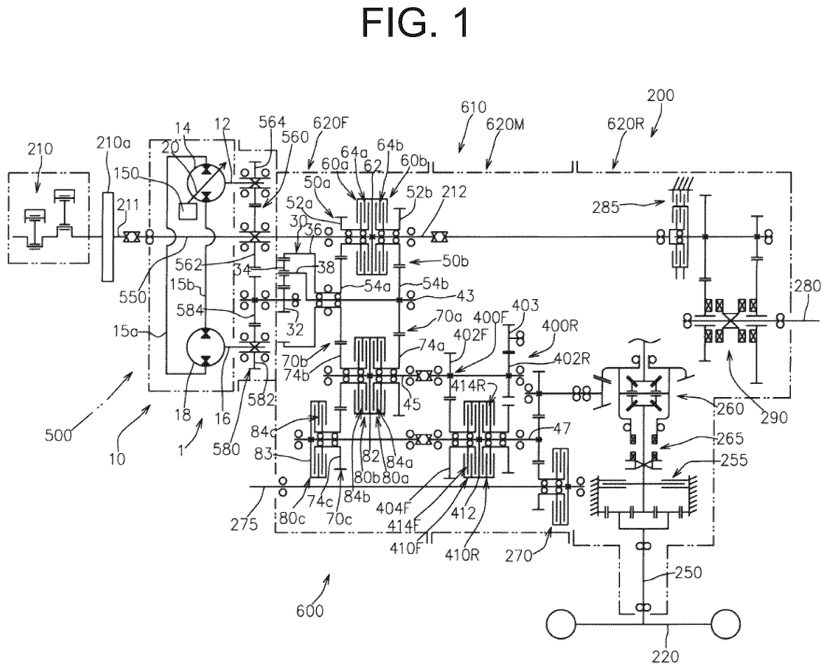

In FIG. 1, a schematic diagram of power transmission in a work vehicle 200 to which an HMT structure 1 according to this embodiment is applied is illustrated.

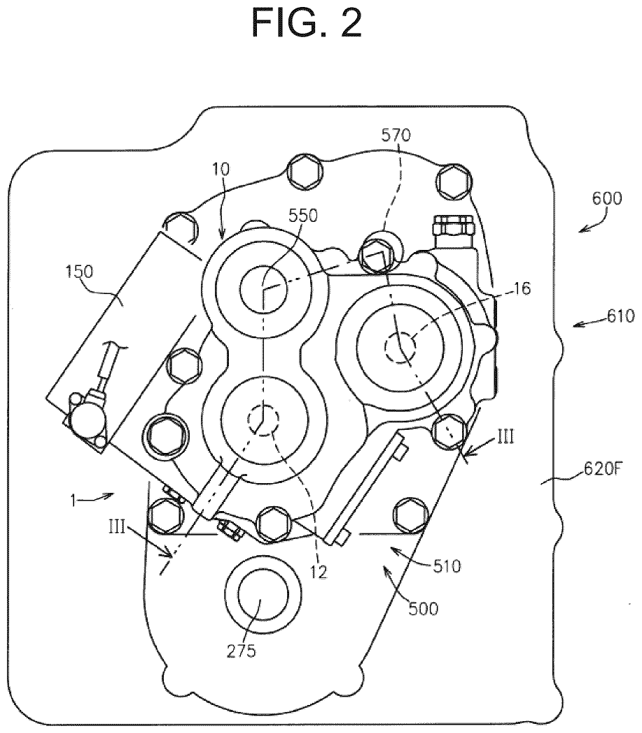

Further, FIG. 2 is a front view of a transmission 600 including the HMT structure 1.

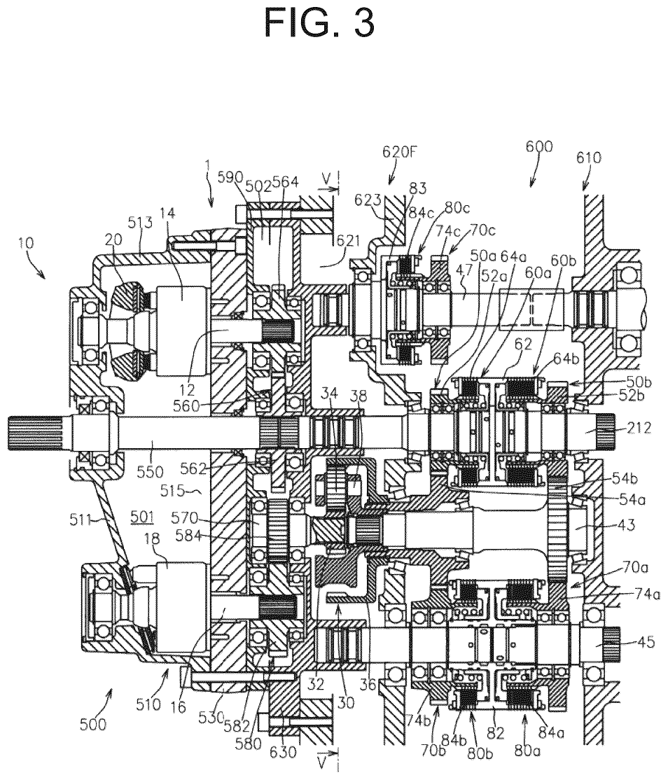

Furthermore, FIG. 3 is a cross-sectional view taken along a line III-III in FIG. 2.

As shown in FIG. 1, the work vehicle 200 includes a drive source 210, a drive wheel 220, and the transmission 600 including the HMT structure 1 interposed in a traveling-system transmission path from the drive source 210 to the drive wheel 220.

Note that a numerical sign 210a in FIG. 1 and FIG. 2 is a flywheel included in the drive source 210.

As shown in FIG. 1 to FIG. 3, the HMT structure 1 includes a hydrostatic continuously variable transmission mechanism (HST) 10 and a planetary gear mechanism 30 that cooperates with the HST 10.

The HST 10 is configured to continuously vary and to output the rotational power operatively transmitted from the drive source 210.

Specifically, as shown in FIG. 1 and FIG. 3, the HST 10 includes a pump shaft 12 which is rotated and driven around an axis by the rotational power operatively transmitted from the drive source 210, an HST pump 14 which is supported by the pump shaft 12, incapable of relative rotation, an HST motor 18 which is fluid-connected to the HST pump 14 via a closed circuit (a pair of first and second HST lines 15a, 15b) and is hydraulically rotated/driven by the HST pump, a motor shaft 16 which supports the HST motor 18, incapable of relative rotation, an output adjusting member 20 which changes a volume of at least either one of the HST pump 14 and the HST motor 18, and an HST case 500 which houses the HST pump 14 and the HST motor 18 and supports the pump shaft 12 and the motor shaft 16 rotatably around an axis.

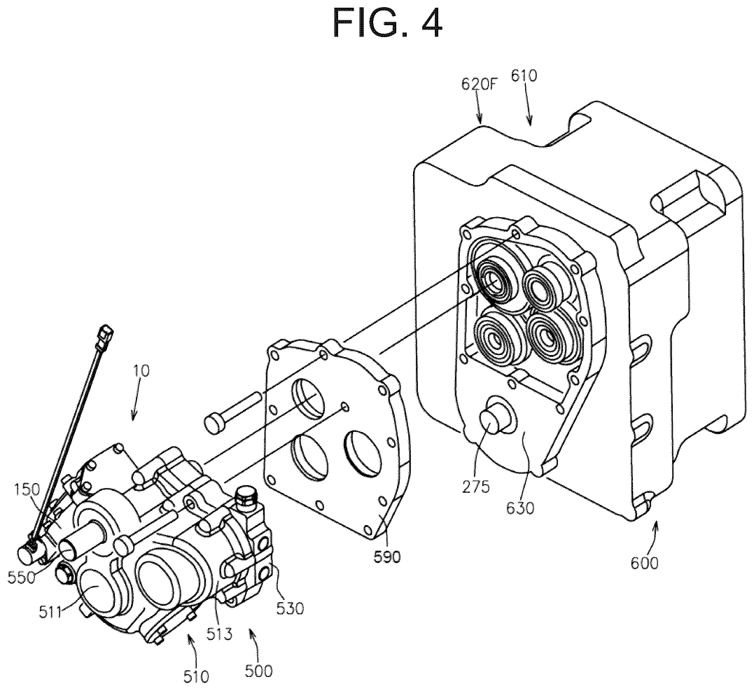

As shown in FIG. 3, the HST case 500 has a case main-body 510 and a port block 530 in which the pair of first and second HST lines 15a and 15b are formed and which is detachably connected to the case main-body 510. FIG. 4 is an exploded perspective view of the HST 10 and the transmission 600.

As shown in FIG. 3 and FIG. 4, the case main-body 510 has a first end wall 511 on one side in the axial direction and a peripheral wall 513 extending from a peripheral edge of the first end wall 511 to the other side in the axial direction, and an opening 515 through which the HST pump 14 and the HST motor 18 can be inserted is provided on the other side in the axial direction.

The port block 530 is detachably connected to the case main-body 510 so as to block the opening 515 and forms a second end wall on the other side in the axial direction of the HST case 500.

As shown in FIG. 3, in this embodiment, the pump shaft 12 and the motor shaft 16 are disposed in parallel to each other.

Specifically, the pump shaft 12 and the motor shaft 16 are supported by the first end wall 511 and the second end wall (the port block 530) rotatably around the axes in a state where the other side in the axial direction extends outward from the second end wall (the port block 530).

The HST pump 14 and the HST motor 18 are supported in an internal space (HST housing space 501) of the HST case 500, incapable of relative rotation around the axes of the pump shaft 12 and the motor shaft 16, respectively.

The HST 10 can continuously vary the ratio of the rotation speed of the HST output outputted from the motor shaft 16 to the rotation speed of the rotational power inputted to the pump shaft 12 (that is, the gear ratio of the HST 10) in accordance with an operation position of the output adjusting member 20.

That is, by assuming that the rotation speed of the rotational power operatively inputted from the drive source 210 to the pump shaft 12 is a reference input speed, the HST 10 continuously varies the rotational power of the reference input speed to the rotational power at least between the first HST speed and the second HST speed in accordance with the operation position of the output adjusting member 20, and outputs the rotational power from the motor shaft 16.

In this embodiment, the HST 10 is configured to be capable of switching a rotational direction of the HST output between forward and reverse.

That is, by assuming that the rotational direction of the reference input speed is the forward direction, the HST 10 is configured to output the rotational power of the first HST speed whose rotational direction is one of the forward and reverse directions (for example, the reverse direction) from the motor shaft 16 when the output adjusting member 20 is positioned at a first operating position, and to output the rotational power of the second HST speed whose rotational direction is the other of the forward and reverse directions (for example, the forward direction) from the motor shaft 16 when the output adjusting member 20 is positioned at a second operating position.

In this case, when the output adjusting member 20 is positioned at a neutral position between the first and second operating positions, the rotation speed of the HST output becomes a neutral speed (zero speed).

In this embodiment, the HST 10 includes, as the output adjusting member 20, a movable swash plate that changes the volume of the HST pump 14 by being swung around a swing shaft and is swingable to one side and the other side around the swing shaft with a neutral position at which the discharge amount discharged from the HST pump 14 is zero interposed therebetween, which is common as an axial piston pump.

When the movable swash plate is positioned at the neutral position, no pressure oil is discharged from the HST pump 14, and the HST 10 is brought into a neutral state where the output of the HST motor 18 is zero. Then, when the movable swash plate is caused to swing from the neutral position to the forward rotation side on the one side around the swing shaft, the pressure oil is supplied from the HST pump 14 to one of the pair of HST lines 15 (for example, the first HST line 15a), and the operating oil circulates in the closed circuit so that the one first HST line 15a becomes a high pressure side and the other second HST line 15b becomes a low pressure side. As a result, the HST motor 18 is rotated and driven to the forward rotation side, and the HST 10 is brought into the forward-rotation output state.

On the other hand, when the movable swash plate is caused to swing from the neutral position to the reverse rotation side on the other side around the swing shaft, the pressure oil is supplied from the HST pump 14 to the other of the pair of HST lines 15 (for example, the second HST line 15b), and the operating oil circulates in the closed circuit so that the other second HST line 15b becomes the high pressure side and the one first HST line 15a becomes the low pressure side.

As a result, the HST motor 18 is rotated and driven to the reverse rotation side, and the HST 10 is in the reverse-rotation output state.

Note that, in the HST 10, the volume of the HST motor 18 is fixed by a fixed swash plate.

The work vehicle 200 further includes a shift operation member (not shown) including a vehicle-speed setting member such as a shift lever operated by a driver and a forward/backward switching operation member such as an FR switching lever, and a control device (not shown) that receives an operation signal from the shift operation member.

The output adjusting member 20 is operatively controlled by the control device in accordance with the operation of the shift operation member.

That is, in this embodiment, the HST 10 has an HST actuator 150 (see FIG. 1 and FIG. 2) that actuates the output adjusting member 20, and the control device actuates the output adjusting member 20 via the HST actuators 150 in accordance with the operation of the shift operating member.

The HST actuator 150 can take various configurations such as an electric motor and an electro-hydraulic mechanism as long as the operation thereof can be controlled by the control device.

In this embodiment, the HST 10 has an electro-hydraulic servo mechanism as the HST actuator 150.

The planetary gear mechanism 30 is configured such that the rotational power operatively transmitted from the drive source 210 is inputted to one element of the three planetary elements acting as a reference-power inputting portion, the HST output operatively transmitted from the HST 10 is inputted to another element of the three planetary elements acting as a variable-power inputting portion, and a synthesized rotational power obtained by synthesizing these rotational powers is outputted from the remaining one of the three planetary elements acting as a synthesized-power outputting portion.

Specifically, as shown in FIG. 1 and FIG. 3, the planetary gear mechanism 30 includes a sun gear 32, a planetary gear 34 meshed with the sun gear 32, an internal gear 36 meshed with the planetary gear 34, and a carrier 38 supporting the planetary gear 34 rotatably around the axis and rotating around the axis of the sun gear 32 in conjunction with revolution of the planetary gear 34 around the sun gear 32, and the sun gear 32, the carrier 38, and the internal gear 36 form the planetary three elements.

In this embodiment, the sun gear 32 is operatively connected to the motor shaft 16 via an HST-output gear train 580 to be described later, and the sun gear 32 acts as a variable-power inputting portion for inputting an HST output.

That is, the HMT structure 1 according to this embodiment further includes the HST-output gear train 580 for operatively transmitting the HST output from a part on the other side in the axial direction extending outward from the HST case 500 in the motor shaft 16 to the planetary gear mechanism 30 (the sun gear 32 in the illustrated embodiment).

Note that, as shown in FIG. 3, the HMT structure 1 according to this embodiment includes an output shaft 570 which is disposed in parallel to the motor shaft 16 and has one side in the axial direction forming an input portion for operatively inputting the HST output from the motor shaft 16 and the other side in the axial direction forming an output portion connected to one corresponding element (the sun gear 32 in the illustrated form) of the planetary gear mechanism 30, incapable of relative rotation around the axis.

Then, the HST-output gear train 580 includes an HST-output drive gear 582 supported by the motor shaft 16, incapable of relative rotation, and an HST-output driven gear 584 meshed with the HST output drive gear 582 in a state of being supported by the output shaft 570, incapable of relative rotation around the axis.

The work vehicle 200 is configured to be capable of selectively realizing a first HMT transmission state where the internal gear 36 is caused to act as a reference-power inputting portion and the carrier 38 is caused to act as a synthesized-power outputting portion, and a second HMT transmission state where the carrier 38 is caused to act as a reference-power inputting portion and the internal gear 36 is caused to act as a synthesized-power outputting portion.

Specifically, as shown in FIG. 1 and FIG. 3, the work vehicle 200 further includes an input-side first transmission mechanism 50a and an input-side second transmission mechanism 50b, capable of operatively transmitting the rotational power of the drive source 210 to the internal gear 36 and the carrier 38, respectively, and an input-side clutch mechanism pair including an input-side first clutch mechanism 60a and an input-side second clutch mechanism 60b, capable of engagement/disengagement of power transmission of the input-side first transmission mechanism 50a and the input-side second transmission mechanism 50b, respectively, and a shift output shaft 45 to which a synthesized rotational power is operatively transmitted from a synthesized-power outputting portion of the planetary gear mechanism 30, an output-side first transmission mechanism 70a and an output-side second transmission mechanism 70b, capable of operatively transmitting the rotational powers of the carrier 38 and the internal gear 36 to the shift output shaft 45, respectively, and an output-side clutch mechanism pair including an output-side first clutch mechanism 80a and an output-side second clutch mechanism 80b for engaging/disengaging the power transmission of the output-side first transmission mechanism 70a and the output-side second transmission mechanism 70b, respectively.

As shown in FIG. 1 and FIG. 3, the input-side first transmission mechanism 50a has an input-side first drive gear 52a relatively rotatably connected to a main drive shaft 212 operatively connected to a driving shaft 211 for outputting the rotational power of the drive source 210, and an input-side first driven gear 54a meshed with the input-side first drive gear 52a and operatively connected to the first element.

As shown in FIG. 1 and FIG. 3, in this embodiment, the work vehicle 200 has a shift intermediate shaft 43 disposed coaxially with the planetary gear mechanism 30 and connected to the carrier 38, incapable of relative rotation around the axis, and the input-side first driven gear 54a is operatively connected to the input-side first drive gear 52a and the internal gear 36 in a state of being supported by the shift intermediate shaft 43, capable of relative rotation.

The input-side second transmission mechanism 50b includes an input-side second drive gear 52b supported by the main drive shaft 212, capable of relative rotation and an input-side second driven gear 54b meshed with the input-side second drive gear 52b and operatively connected to the second element.

In this embodiment, the input-side second driven gear 54b is meshed with the input-side second drive gear 52b in a state of being supported by the shift intermediate shaft 43, incapable of relative rotation, which is connected to the carrier 38, incapable of relative rotation.

In this embodiment, the input-side first and second clutch mechanisms 60a, 60b are hydraulic friction-plate clutch mechanisms.

The input-side first and second clutch mechanisms 60a, 60b are supported by the main drive shaft 212 so as to engage/disengage the input-side first and second drive gears 52a, 52b with respect to the main drive shaft 212, respectively.

The input-side first clutch mechanism 60a has an input-side clutch housing 62 supported by the main drive shaft 212, incapable of relative rotation, an input-side first friction-plate group 64a including a first drive-side friction-plate supported by the input-side clutch housing 62, incapable of relative rotation, and a first driven-side friction-plate supported by the input-side first drive gear 52a, incapable of relative rotation, in a state of being superposed on the first drive-side friction-plate, and an input-side first piston (not shown) capable of pressing and frictionally engaging the input-side first friction-plate group 64a.

The input-side second clutch mechanism 60b has the input-side clutch housing 62, an input-side second friction-plate group 64b including a second drive-side friction-plate supported by the input-side clutch housing 62, incapable of relative rotation, and a second driven-side friction-plate supported by the input-side second drive-gear 52b, incapable of relative rotation, in a state of being superposed on the second drive-side friction-plate, and an input-side second piston (not shown) capable of pressing and frictionally engaging the input-side second friction-plate group 64b.

The output-side first transmission mechanism 70a is configured to be capable of transmitting the rotational power of the carrier 38 to the shift output shaft 45.

In this embodiment, the output-side first transmission mechanism 70a is configured to be capable of operatively transmitting the rotational power of the second element to the shift output shaft 45 by using the input-side second driven gear 54b in the input-side second transmission mechanism 50b.

Specifically, as shown in FIG. 1 and FIG. 3, the output-side first transmission mechanism 70a has the input-side second driven gear 54b and an output-side first driven gear 74b that is operatively connected to the input-side second driven gear 54b in a state of being supported by the shift output shaft 45, capable of relative rotation.

The output-side second transmission mechanism 70b is configured to be capable of transmitting the rotational power of the internal gear 36 to the shift output shaft 45.

In this embodiment, the output-side second transmission mechanism 70b is configured to be capable of operatively transmitting the rotational power of the internal gear 36 to the shift output shaft 45 by using the input-side first driven gear 54a in the input-side first transmission mechanism 50a.

Specifically, as shown in FIG. 1 and FIG. 3, the output-side second transmission mechanism 70b includes the input-side first driven gear 54a and an output-side second driven gear 74b that is operatively connected to the input-side first driven gear 54a in a state of being supported by the shift output shaft 45, capable of relative rotation.

The output-side first and second clutch mechanisms 80a, 80b are hydraulic friction-plate clutch mechanisms.

In this embodiment, the output-side first and second clutch mechanisms 80a, 80b are supported by the shift output shaft 45 so as to engage/disengage the output-side first and second driven gears 74a, 74b with and from the shift output shaft 45, respectively.

The output-side first clutch mechanism 80a has an output-side clutch housing 82 supported by the shift output shaft 45, incapable of relative rotation, an output-side first friction-plate group 84a including a first drive-side friction-plate supported by the output-side first driven gear 74a, incapable of relative rotation, and a first driven-side friction-plate supported by the output-side clutch housing 82, incapable of relative rotation, in a state of being superposed on the first drive-side friction-plate, and an output-side first piston (not shown) capable of pressing and frictionally engaging the output-side first friction-plate group.

The output-side second clutch mechanism 80b has the output-side clutch housing 82, an output-side second friction-plate group 84b including a second drive-side friction-plate supported by the output-side second driven gear 74b, incapable of relative rotation, and a second driven-side friction-plate supported by the output-side clutch housing 82, incapable of relative rotation, in a state of being superposed on the second drive-side friction-plate, and an output-side second piston (not shown) capable of pressing and frictionally engaging the output-side second friction-plate group 84b.

The work vehicle 200 further includes a clutch actuator that switches between engagement/disengagement of the input-side first clutch mechanism 60a, the input-side second clutch mechanism 60b, the output-side first clutch mechanism 80a, and the output-side second clutch mechanism 80b via the pistons provided therein, respectively.

The clutch actuator only needs to be a mechanism which can be electrically and operatively controlled by the control device and can take various configurations such as an electric motor and an electro-hydraulic mechanism. For example, the clutch actuator is an electro-hydraulic mechanism which is operatively controlled by a solenoid valve.

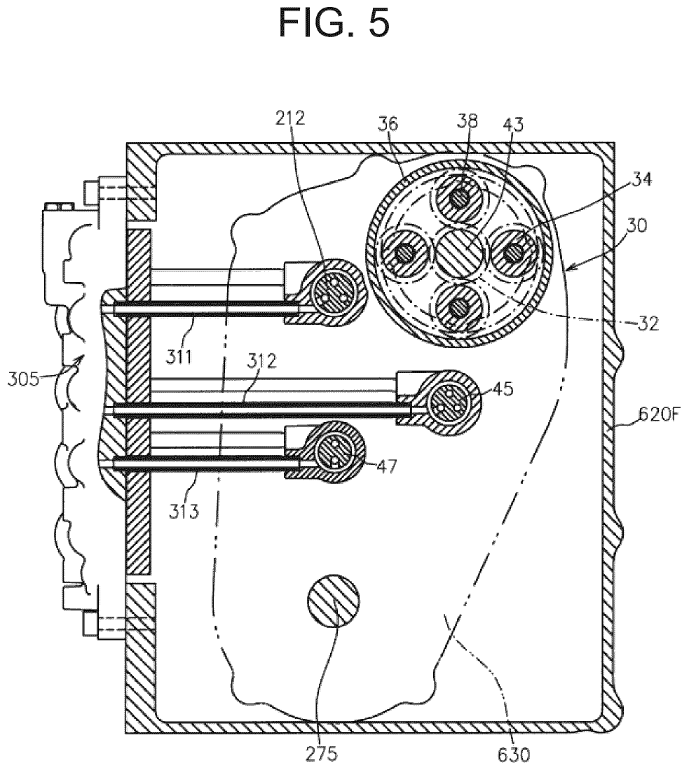

FIG. 5 is a cross-sectional view taken along a line V-V in FIG. 3. As shown in FIG. 1, FIG. 3, and FIG. 5, the work vehicle 200 further includes a travel output shaft 47 that outputs a drive rotational power toward the drive wheel 220, a forward-side transmission mechanism 400F and a reverse-side transmission mechanism 400R that operatively transmit the rotational power of the shift output shaft 45 to the travel output shaft 47 as a drive rotational power in the forward direction and the reverse direction, respectively, a hydraulic friction-plate type forward-side clutch mechanism 410F and reverse-side clutch mechanism 410R that engage/disengage the power transmission of the forward-side transmission mechanism 400F and the reverse-side transmission mechanism 400R, respectively, an output-side third transmission mechanism 70c capable of operatively transmitting a rotational power of the internal gear 36 to the travel output shaft 47 as a drive rotational power in the forward direction, and an output-side third clutch mechanism 80c that engages/disengages the power transmission of the output-side third transmission mechanism 70c.

The forward-side transmission mechanism 400F has a forward-side gear train including a forward-side drive gear 402F supported by the shift output shaft 45 and a forward-side driven gear 404F meshed with the forward-side drive gear 402F in a state of being supported by the travel output shaft 47.

In this embodiment, the forward-side drive gear 402F is supported by the shift output shaft 45, incapable of relative rotation, and the forward-side driven gear 404F is supported by the travel output shaft 47, capable of relative rotation.

The reverse-side transmission mechanism 400R has a reverse-side gear train including a reverse-side drive gear 402R supported by the shift output shaft 45 and a reverse-side driven gear 404R meshed with the reverse-side drive gear 402R via an idle gear 403 (see FIG. 1) in a state of being supported by the travel output shaft 47.

In this embodiment, the reverse-side drive gear 402R is supported by the shift output shaft 45, incapable of relative rotation, and the reverse-side driven gear 404R is supported by the travel output shaft 47, capable of relative rotation.

In this embodiment, the forward-side clutch mechanism 410F and the reverse-side clutch mechanism 410R are supported by the travel output shaft 47 so as to engage/disengage the forward-side driven gear 404F and the reverse-side driven gear 404R with and from the travel output shaft 47, respectively.

Specifically, the forward-side clutch mechanism 410F has a forward-reverse clutch housing 412 supported by the travel output shaft 47, incapable of relative rotation, the forward friction-plate group 414F including a forward driven-side friction-plate supported by the forward-reverse clutch housing 412, incapable of relative rotation, and a forward drive-side friction-plate supported by the forward-side driven gear 404F, incapable of relative rotation, in a state opposed to the forward driven-side friction-plate, and a forward-side piston (not shown) capable of pressing and frictionally engaging the forward-side friction-plate group 414F.

The reverse-side clutch mechanism 410R has the forward-reverse clutch housing 412, a reverse-side friction-plate group 414R including a reverse driven-side friction-plate supported by the forward-reverse clutch housing 412, incapable of relative rotation, and a reverse drive-side friction-plate supported by the reverse-side driven gear 404R, incapable of relative rotation, in a state of being superposed on the reverse drive-side friction-plate, and a reverse-side piston (not shown) capable of pressing and frictionally engaging the reverse-side friction-plate group 414R.

The forward-reverse switching actuator 350 is configured to engage/disengage the forward-side clutch mechanism 410F and the reverse-side clutch mechanism 410Rb by being operatively controlled by the control device in response to the operation of the shift operation member.

The output-side third transmission mechanism 70c has a gear ratio set such that the rotation speed of the travel output shaft 47 when the rotational power of the first element is operatively transmitted to the travel output shaft 47 via the output-side third transmission mechanism 70c is higher than the rotation speed of the travel output shaft 47 when the rotational power of the first element is operatively transmitted to the travel output shaft 47 via the output-side second transmission mechanism 70b and the forward-side transmission mechanism 400F.

In this embodiment, the output-side third transmission mechanism 70c is configured to be able to operatively transmit the rotational power of the first element to the travel output shaft 47 by using the output-side second driven gear 74b in the output-side second transmission mechanism 70b.

Specifically, as shown in FIG. 1 and FIG. 3, the output-side third transmission mechanism 70c has the output-side second driven gear 74b and an output-side third driven gear 74c that is operatively connected to the output-side second driven gear 74b in a state of being supported by the travel output shaft 47 capable of relative rotation.

The output-side third clutch mechanism 80c is supported by the travel output shaft 47 so as to engage/disengage the output-side third driven gear 74c with and from the travel output shaft 47.

Specifically, the output-side third clutch mechanism 80c includes an output-side clutch housing 83 supported by the travel output shaft 47, incapable of relative rotation, an output-side third friction-plate group 84c including a third drive-side friction-plate supported by the output-side third driven gear 74c, incapable of relative rotation, and a third driven-side friction-plate supported by the output-side clutch housing 83, incapable of relative rotation, in a state of being superposed on the third drive-side friction-plate, and an output-side third piston (not shown) capable of pressing and frictionally engaging the output-side third friction-plate group 84c.

The forward-side clutch mechanism 410F, the reverse-side clutch mechanism 410R, and the output-side third clutch mechanism 80c are engaged/disengaged by the clutch actuators.

As shown in FIG. 1, the work vehicle 200 has a pair of left and right main drive wheels as the drive wheels 220.

Therefore, the work vehicle 200 further has a pair of main drive axles 250 that drive the pair of main drive wheels, respectively, and a differential mechanism 260 that differentially transmits the rotational power of the travel output shaft to the pair of main drive axles 250.

As shown in FIG. 1, the work vehicle 200 further has a travel brake mechanism 255 that selectively applies a braking force to the main drive axle 250, a differential lock mechanism 265 that forcibly and synchronously drives the pair of main drive axles 250, capable of differential rotation by the differential mechanism 260, an auxiliary drive-wheel output shaft 275 that outputs a travel rotational power to the auxiliary drive wheel, and a power taking-out mechanism 270 for the auxiliary drive wheel that selectively transmits the rotational power taken out of the travel output shaft 47 to the auxiliary drive-wheel output shaft 275.

Further, the work vehicle 200 has a PTO shaft 280 that outputs the rotational power of the drive source 210 to the outside, and a PTO clutch mechanism 285 and a PTO multi-stage transmission mechanism 290 interposed in a PTO transmission path from the drive source 210 to the PTO shaft 280.

The HMT structure 1 is configured to vary (normally, increase) the speed of the rotational power from the drive source 210 and to input it to the pump shaft 12.

Specifically, as shown in FIG. 1 and FIG. 3, the HMT structure 1 further has an input shaft 550 disposed in parallel to the pump shaft 12 and the motor shaft 16 and having one side in the axial direction operatively connected to the flywheel 210a and the other side in the axial direction extending to the other side in the axial direction from the HST pump 14, and an HST-input gear train 560 for operatively transmitting the rotational power from the input shaft 550 to the pump shaft 12.

The input shaft 550 is supported by the HST case 500 rotatably around the axis in a state where one side in the axial direction extends outward from the HST case 500 (the first end wall 511 of the case main-body 510) to one side in the axial direction and the other side in the axial direction extends from the HST case 500 (the port block 530) to the other side in the axial direction.

A gear ratio of the HST-input gear train 560 is set such that, when the rotation speed (output rotation speed) of the rotational power of the drive source 210 such as a diesel engine is lower than an allowable input rotation speed (allowable rotation speed) of the HST 10, the rotation speed of the rotational power inputted into the pump shaft 12 is increased to an appropriate rotation speed with respect to an allowable input rotation speed of the HST 10.

Here, in the HMT structure 1 according to this embodiment, as shown in FIG. 3, the HMT-input gear train 560 is disposed between the HST pump 14 and the HST motor 18 as well as the planetary gear mechanism 30 in the axial direction together with the HST-output gear train 580, whereby reduction of a length in the axial direction of the entire HMT structure 1 including the HST 10, the planetary gear mechanism 30, the HST-input gear train 560, and the HST-output gear train 580 is promoted.

That is, in the conventional HMT structure, the HST-input gear train for increasing the speed of a rotational power from the drive source and transmitting the rotational power to the pump shaft of the HST and the HST-output gear train for operatively transmitting the HST output from the motor shaft of the HST to a corresponding element (for example, a sun gear) of the planetary gear mechanism are separated and disposed on one side and the other side in the axial direction with the HST interposed therebetween.

On the other hand, in the HMT structure 1 according to this embodiment, the HST-input gear train 560 and the HST-output gear train 580 are collectively disposed between the HST pump 14 as well as the HST motor 16 and the planetary gear mechanism 18 with respect to the axial direction such that the length in the axial direction of the entire HMT structure 1 can be reduced as much as possible.

Specifically, as shown in FIG. 1 and FIG. 3, the HST-input gear train 560 includes an HST-input drive gear 562 supported, incapable of relative rotation around the axis, by a part of the input shaft 550 extending from the HST case 500 toward the other side in the axial direction and an HST-input driven gear 564 meshed with the HST-input drive gear 562 in a state of being supported by the pump shaft 12, incapable of relative rotation around the axis, and is disposed so as to at least partially overlap the HST-output gear train 580 in the axial direction.

In the HMT structure 1 according to this embodiment, the HST-input gear train 560 and the HST-output gear train 580 are disposed between the HST case 500 and the transmission case 610.

Specifically, as shown in FIG. 1 to FIG. 5, the work vehicle 200 includes the transmission case 610 that houses the plurality of transmission mechanisms 50a to 50b and 70a to 70c and the plurality of clutch mechanisms 60a to 60b, 80a to 80c, and 410R, 410F.

In this embodiment, the planetary gear mechanism 30 is also housed in the transmission case 610. Oil for lubricating and cooling various gears and bearings is stored in the transmission case 610 and moreover, the oil is also used as the operating oil of the HST 10 by the charge pump (not shown) as described above.

In this embodiment, the transmission case 610 includes a TM case main-body 620 in which an opening 621 is provided in an end surface on one side in the axial direction, and a lid-typed TM bearing wall 630 including a rear surface covering the opening 621 and detachably connected to the TM case main-body 620.

The TM case main-body 620 includes a front case 620F, a mid case 620M, and a rear case 620R connected in order from one side to the other side in the axial direction, and the opening 621 is provided in the front case 620F, and the TM bearing wall 630 is connected to the front case 620F.

As shown in FIG. 1 and FIG. 3, the planetary gear mechanism 30, the input-side first and second transmission mechanisms 50a, 50b, the input-side first and second clutch mechanisms 60a, 60b, the output-side first and second transmission mechanisms 70a, 70b, the output-side first and second clutch mechanisms 80a, 80b, the output-side third transmission mechanism 70c, and the output-side third clutch mechanism 80c are housed in the front case 420F.

A reference numeral 623 in FIG. 3 denotes a partition wall attached to the front case 620F so as to separate the internal space of the front case 620F into one side and the other side in the axial direction.

Note that the forward-side transmission mechanism 400F, the forward-side clutch mechanism 410F, the reverse-side transmission mechanism 400R, the reverse-side clutch mechanism 410R, and the power taking-out mechanism 270 for the auxiliary drive wheel are housed in the mid case 620M.

The deferential mechanism 260, the differential lock mechanism 265, the travel brake mechanism 255, the PTO clutch mechanism 285, and the PTO multi-stage transmission mechanism 290 are housed in the rear case 620R.

Further, a reference numeral 305 in FIG. 5 denotes a valve unit in which valves for switching between supply and discharge of the operating oil to and from the plurality of clutch mechanisms 60a to 60b, 80a to 80c, 410F, 410R are collectively disposed, and the valve unit functions as the clutch actuator. The valve unit 305 is connected to a side surface of the transmission case 610 (the front case 620F).

Further, reference numerals 311 to 313 denote pipes for fluidly connecting the supply/discharge oil passages for the input-side first and second clutch mechanisms 60a, 60b formed in the main drive shaft 212, the supply/discharge oil passages for the output-side first and second clutch mechanisms 80a, 80b formed in the shift output shaft 45, and the supply/discharge oil passages for the output-side third clutch mechanism 80c formed in the travel output shaft 47 to the corresponding oil passages formed in the valve unit 305, respectively.

The rear surface of the TM bearing wall 630 has an oil-passage receiving cylindrical portion which covers outer peripheral surfaces on distal end sides of the travel output shaft 47, the main drive shaft 212, and the shift output shaft 45 provided, and distal ends of the pipes 311 to 313 are inserted into the oil-passage receiving cylindrical portion, whereby each of the clutch mechanisms 60a, 60b, 80a, 80b, 80c is connected to the valve unit 305, capable of supply and discharge of a fluid.

In the HMT structure 1 according to this embodiment, the HST case 500 is connected to one side in the axial direction of the transmission case 610 (the front case 620F) in a state where a gear housing space 502 in which the HST-input gear train 560 and the HST-output gear train 580 are housed is defined between the TM bearing wall 630 and the HMT case 500.

Specifically, as shown in FIG. 3 and FIG. 4, the HMT structure 1 includes a connecting cover 590 which is detachably connected to the TM bearing wall 630 so that the gear housing space 502 is defined between the TM bearing wall 630 and the connecting cover 590 on a surface on a side opposite to a side on which the HST case 500 is mounted.

As shown in FIG. 3, one sides in the axial direction of the gears 562, 564 of the HST-input gear train 560 and the gears 582, 584 of the HST-output gear train 580 are supported rotatably around the axis by the connecting cover 590. The other sides in the axial direction of them are supported by the TM bearing wall 630 rotatably around the axis.

An overflow of a predetermined amount of the operating oil having collected in the HST case 500 or the operating oil discharged from the pair of first and second HST lines 15a, 15b to the outside of the port block 530 is guided to the gear housing space 502 through a through hole (not shown) opened in an upper part of a joined surface between the port block 530 and the connecting cover 590. The introduced oil is splashed on parts such as gears, shafts, and bearings that rotate in association with the HST-input gear train 560 and the HST-output gear train 580 so as to lubricate and cool the parts.

The operating oil in the gear housing space 502 flows to the front case 620F through a through hole (not shown) opened in the lower part of the rear surface of the TM bearing wall 630 and is returned to an oil reservoir of the transmission case 610. By means of this circulation, the operating oil in the gear housing space 502 is refreshed all the time, and an excessive rise in an oil temperature can be suppressed.

### Embodiment 2

Hereinafter, an embodiment of an HST unit according to the present invention will be explained with reference to the accompanying drawings.

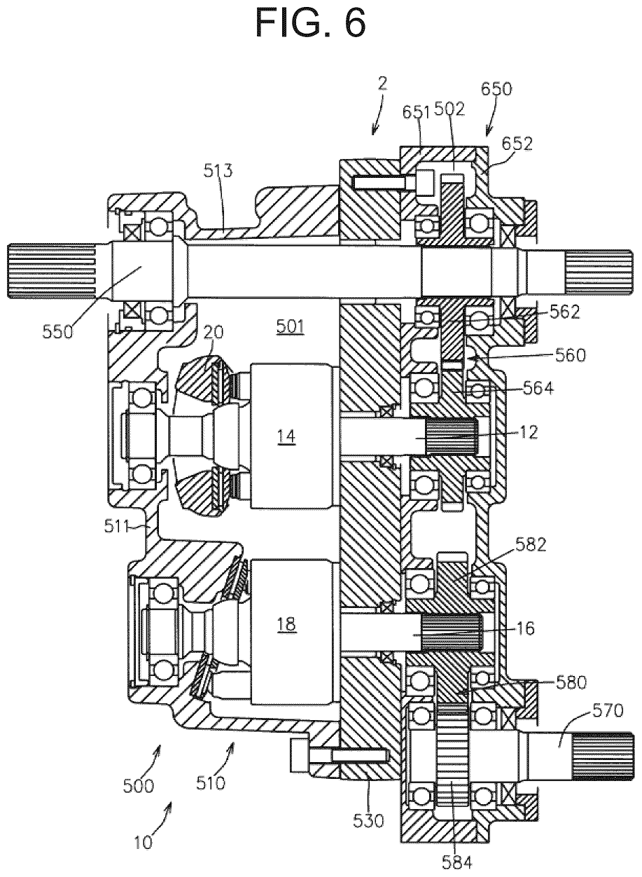

FIG. 6 illustrates a cross-sectional view of an HST unit 2 according to this embodiment.

Note that, in the drawings, the same members as those in Embodiment 1 are denoted by the same reference numerals.

The HST unit 2 includes the HST 10, the input shaft 550, the HST-input gear train 560, the output shaft 570, the HST-output gear train 580, and a gear case 650.

The gear case 650 is configured to form the gear housing space 502 that houses the HST-input gear train 560 and the HST-output gear train 580 and to be detachably connected to the HST case 500.

In this embodiment, the HST case 500 and the gear case 650 form a housing having the HST housing space 501 that houses the HST pump 14 and the HST motor 18, and the gear housing space 502 that houses the HST-input gear train 560 and the HST-output gear train 580.

The gear case 650 has a first cover 651 connected to the HST case 500 (the port block 530 in the illustrated form) and a second cover 652 connected to the first cover 651 along the axial direction capable of separation/joining so as to form the gear housing space 502.

The input shaft 550 extends into the HST housing space 501 and the gear housing space 502 and is supported by the housing rotatably around the axis in a state where the one side in the axial direction acting as the input portion is accessible from the one side in the axial direction of the housing (the HST case 500) and the other side in the axial direction is accessible from the other side in the axial direction of the housing (the gear case 650).

In this embodiment, as shown in FIG. 6, the input shaft 550 is supported by the HST case 500 and the gear case 650 rotatably around the axis in a state where the one side in the axial direction extends outward from the HST case 500 and the other side in the axial direction extends outward from the gear case 650.

The pump shaft 12 and the motor shaft 16 are supported by the housing (the HST case 500) rotatably around the axes in a state where the pump shaft 12 and the motor shaft 16 extend into the HST housing space 501, and the other sides in the axial direction protrude into the gear housing space 502.

In this embodiment, as shown in FIG. 6, the pump shaft 12 and the motor shaft 16 are supported by the HST case 500 rotatably around the axes in a state where the other sides in the axial direction protrude into the gear housing space 502 from the HST case 500.

The output shaft 570 is supported by the housing rotatably around the axis in a state where the other side in the axial direction acting as the output portion is accessible from the other side in the axial direction of the housing (the gear case 650).

In this embodiment, as shown in FIG. 6, the output shaft 570 is supported by the gear case 650 rotatably around the axis in a state where the other side in the axial direction acting as the output portion extends outward from the gear case 650.

### Embodiment 3

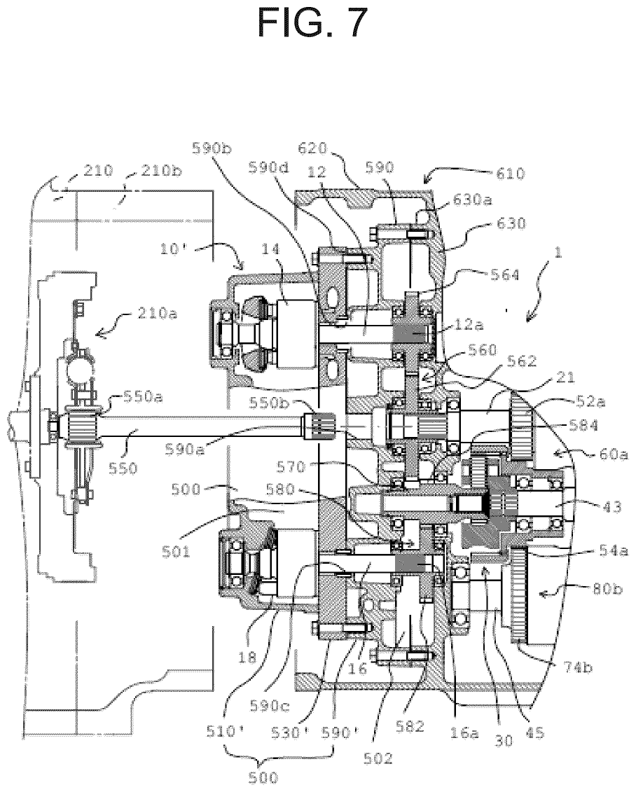

Hereinafter, a form of an HMT structure according to the present invention will be explained with reference to FIG. 7 to FIG. 9.

Note that, in the drawings, the members with the same functions as those in Embodiment 1 are denoted by the same reference numerals, and detailed explanation will be omitted.

In the embodiments 1 and 2, the input shaft 550 is housed in the case main-body 510 (HST housing space 501) of the HST 10 and is rotatably bearing-supported between the case-main-body 510 and the port block 530, but in this embodiment, the input shaft 550 is located outside a case main-body 510′ and is not supported by a case main-body 510′ or a port block 530′. That is, it is the HMT structure which can employ an extremely general-purpose HST 10′ in which the HST pump 14 and the HST motor 18 are only housed in the case main-body 510′.

The input shaft 550 is located on an outer side of the HST 10′ and is disposed in parallel to the pump shaft 12 and the motor shaft 16.

On one side in an axial direction of the input shaft 550, a first connection end 550a connected to the flywheel 210a located on the drive source 210 side via a damper and bearing-supported by an inertia body on a crank shaft end is provided. Moreover, a second connection end 550b, which is a part extending closer to the other side in the axial direction than the HST pump 14 and for engaging the HST-input drive gear 562, incapable of relative rotation, is provided.

In the TM case main-body 620, in this embodiment, a TM bearing wall 630′ is provided by being integrally formed on one side in the axial direction thereof. On the TM bearing wall 630′, a bearing support portion which supports the HST-input gear train 560 and the HST-output gear train 580 is formed on the one side in the axial direction. On the other side, a bearing portion which supports the main drive shaft 212 and the shift output shaft 45 is formed.

On an outer surface of the TM bearing wall 630′, a bearing surface 630a on which the connecting cover 590′, which is a constituent component of the HST case 500, is mounted is formed by protruding toward the one side in the axial direction. The TM bearing wall 630′ beating-supports the HST-input gear train 560 and the HST-output gear train 580 in cooperation with the connecting cover 590′. The bearing surface 630a has a peripheral-wall shape in this embodiment and stores lubricating oil for various gears and bearings present in the gear housing space 502 in collaboration with the connecting cover 590′.

The HST case 500 is constituted by mutually connecting the case main-body 510′, the port block 530′, and the connecting cover 590′. On an outer wall surface of the connecting cover 590′, similarly to the embodiment 1, first to third openings 590a, 590b, and 590c which make the port block 530′ mountable and communicate with the gear housing space 502 are provided.

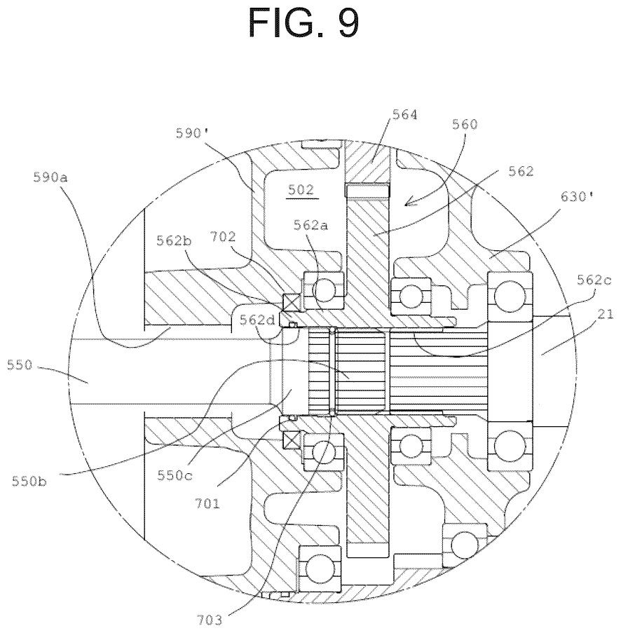

With respect to the first opening 590a, a hollow-state bearing boss portion 562a (see FIG. 9) provided in a rotary center-hole portion of the HST-input drive gear 562 is faced. And in order to be engaged with a female spline of the bearing boss portion, the second connection end 550b of the input shaft 550 is formed with such a size that can be inserted into the bearing boss portion.

Similarly to the above, the second opening 590b is faced with a hollow-shaped bearing boss portion provided in a rotary center portion of the HST-input driven gear 564. And in order to be engaged with a female spline of the bearing boss portion, it is formed with such a size that a connection portion 12a of the pump shaft 12 can be inserted.

The third opening 590c is faced with a hollow-shaped bearing boss portion provided in a rotary center portion of the HST-output drive gear 582. And in order to be engaged with a female spline of the bearing boss portion, a connection portion 16a of the motor shaft 16 is formed with such a size that can be inserted into the bearing boss portion.

Outer shapes of the case main-body 510′ in the HST case 500 and the port block 530′ are formed smaller as compared with the embodiment 1 described above only for a portion not supporting the input shaft 550. From an outer end surface of the port block 530′, the connection portion 12a of the pump shaft 12 and the connection portion 16a of the motor shaft 16 extend toward the other side in the axial direction.

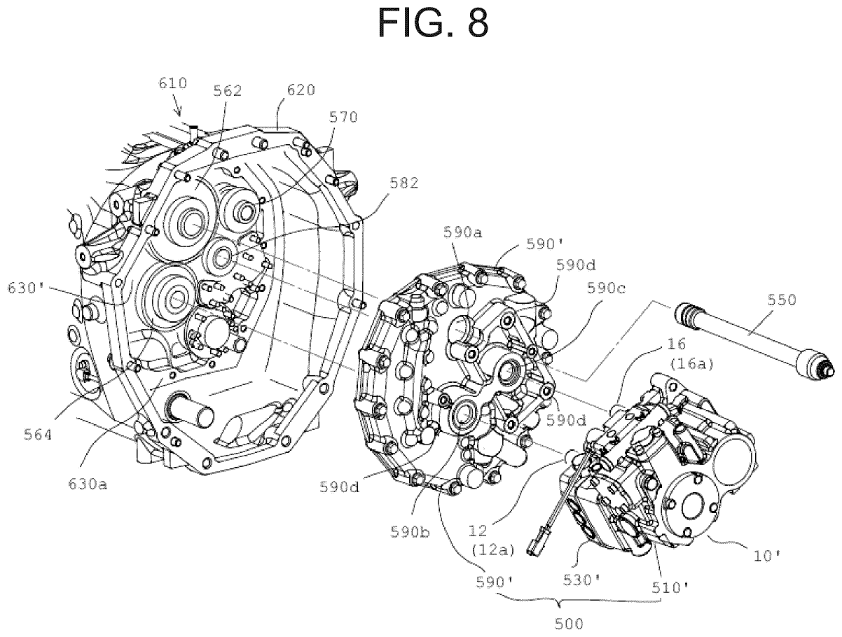

As shown in FIG. 8, on the outer wall surface of the connecting cover 590′, a bearing surface 590d for attaching the port block 530′ is formed by protruding toward the one side in the axial direction. The bearing surface 590d is disposed in compliance with an outer shape of the port block 530′ and defines an HST attachment region by surrounding the second and third openings 590b, 590c. The first opening 590a is provided at a position avoiding the HST attachment region.

When the port block 530′ is attached to the connecting cover 590′, the connecting portion 12a of the pump shaft 12 and the connecting portion 16a of the motor shaft 16 are located in the gear housing space 502 via the second and third openings 590b, 590c and are interlockingly connected to the HST-input gear train 560 and the HST-output gear train 580. Moreover, the second and third openings 590b, 590c are sealed via the outer end surface of the port block 530′.

When the flywheel case 210b in which the flywheel 210a is housed is connected and fixed between the drive source (engine) 210 and the TM case main-body 620, the second connecting end 550a of the input shaft 550 is inserted into the first opening 590a of the connecting cover 590′ and is engaged with the bearing boss portion of the HST-input drive gear 562.

In this embodiment, an oil sealing mechanism 700 is provided in the first opening 590a opened in the connecting cover 590′ in a state out of the HST attachment region. The oil sealing mechanism 700 functions such that the oil stored in the gear housing space 502 does not leak out of a gap between an opening inner peripheral surface of the first opening 590a and an outer peripheral surface of the input shaft 550 inserted therein.

Specifically, an essential part thereof is shown in FIG. 9 in an enlarged manner.

The bearing boss portion 562a located on the one side in the axial direction of the HST-input drive gear 562 includes an extended end 562b going further than a bearing placing portion for holding the bearing between the bearing boss portion 562a and the connecting cover 590′ toward the one side in the axial direction.

On an inner peripheral side of the bearing boss portion 562a, a female spline 562c for power transmission is engraved toward the other side from the vicinity of a center part in the axial direction, and a circumferential surface 562d without irregularity is provided from the vicinity of the center part in the axial direction to the extended end 562b.

On the other hand, in the second connection end 550b of the input shaft 550 inserted into the first opening 590a, a male spline which can be engaged with the female spline is engraved, and a cylindrical surface 550c without irregularity is provided from a terminal end thereof toward the one side in the axial direction.

A seal ring 701 is interposed at a portion where the cylindrical surface 550c and the circumferential surface 562d overlap each other in the axial direction so that they are brought into close contact without a gap. As a result, the oil in the gear housing space 502 enters into the bearing boss portion 562a and lubricates the male and female splines and at this time, leaking-out toward the first opening 590a is prevented. Note that the seal ring 701 is held in a shallow groove dug at a part of the circumferential surface 562c in this embodiment, but it may be held similarly on the side of the cylindrical surface 550c.

On the outer peripheral surface of the extended end 562b in the bearing boss portion 562a of the HST-input drive gear 562, an oil seal 702 is placed so as to block the gap between it and the connecting cover 590′. As a result, the oil in the gear housing space 502 enters into the bearing of the bearing boss portion 562a and lubricates the same and at this time, leaking-out toward the first opening 590a is prevented. Note that the sign 703 is a C-shaped retaining ring retained incapable of movement in the axial direction in the second connection end 550b of the input shaft 550 and is used to maintain close contact between the seal ring 701 with the cylindrical surface 550c and the circumferential surface 562d by preventing movement of the input shaft 550 to the other side in the axial direction.

### REFERENCE SIGNS LIST

1 HMT structure
2 HST unit
10, 10′ HST
12 Pump shaft
14 HST pump
16 Motor shaft
18 HST motor
20 Output adjusting member
30 Planetary gear mechanism
45 Shift output shaft
47 Travel output shaft
210 Drive source
220 Drive wheel
500 HST case
501 HST housing space
502 Gear housing space
510, 510′ Case main-body
530, 530′ Port block
550 Input shaft
560 HST-input gear train
562 HST-input drive gear
564 HST-input driven gear
580 HST-output gear train
582 HST-output drive gear
584 HST-output driven gear
590 Connecting cover
610 Transmission case
620 TM case main-body
630, 630′ TM bearing wall
650 Gear case

1. An HMT structure comprising an HST for continuously varying a rotational power operatively transmitted from a drive source and outputting the same and a planetary gear mechanism for synthesizing the rotational power operatively transmitted from the drive source and an HST output operatively transmitted from the HST and outputting the same, wherein
an input shaft disposed in parallel to a pump shaft and a motor shaft of the HST and having one side in an axial direction operatively connected to the drive source and the other side in the axial direction extending from an HST pump of the HST to the other side in the axial direction;
an HST-input gear train for operatively transmitting the rotational power from the input shaft to the pump shaft; and
an HST-output gear train for operatively transmitting the HST output from the motor shaft to the planetary gear mechanism are provided; and
the HST-input gear train and the HST-output gear train are disposed between the HST pump and the HST motor, and the planetary gear mechanism in the axial direction.

2. The HMT structure according to claim 1, wherein the HST-input gear train and the HST-output gear train are disposed such that the HST-input gear train and the HST-output gear train overlap each other at least partially with respect to the axial direction.

3. The HMT structure according to claim 2, further comprising an output shaft disposed in parallel to the motor shaft and having one side in an axial direction forming an input portion for operatively inputting an HST output from the motor shaft and the other side in the axial direction forming an output portion for outputting the HST output to the planetary gear mechanism, wherein
the HST-output gear train operatively transmits the HST output from the motor shaft to the output shaft.

4. The HMT structure according to claim 3, wherein the HST-input gear train includes an HST-input drive gear supported by the input shaft, incapable of relative rotation around an axis, and an HST-input driven gear meshed with the HST-input drive gear in a state of being supported by the pump shaft, incapable of relative rotation around the axis; and
the HST-output gear train includes an HST-output drive gear supported by the motor shaft, incapable of relative rotation, and an HST-output driven gear meshed with the HST-output drive gear in a state of being supported by the output shaft, incapable of relative rotation around the axis.

5. The HMT structure according to claim 1, wherein the HST includes an HST case that houses the HST pump and the HST motor and supports the pump shaft and the motor shaft rotatably around axes;
the planetary gear mechanism is housed in a transmission case including a TM bearing wall on one side in the axial direction;
the HST case is directly or indirectly connected to one side in the axial direction of the transmission case such that a gear housing space is defined between the HST case and the TM bearing wall; and
the HST-input gear train and the HST-output gear train are housed in the gear housing space.

6. The HMT structure according to claim 5, further comprising a connecting cover detachably connected to the HST case and detachably connected to the TM bearing wall such that the gear housing space is defined between the HST case and the TM bearing wall, wherein
a gear of the HST-input gear train and a gear of the HST-output gear train are supported rotatably around an axis by the connecting cover on one side in the axial direction and are supported rotatably around the axis by the TM bearing wall on the other side in the axial direction.

7. The HMT structure according to claim 5, wherein
the connecting cover has an opening which is provided, in an outer wall surface on a side where the HST case is attached, at a position avoiding an HST attachment region, and communicates with the gear housing space; and
the extended portion of the input shaft is drivably connected to the HST-input gear train through the opening.

8. An HST unit having an HST which continuously varies a rotational power inputted into a pump shaft and outputs the same from a motor shaft disposed in parallel to the pump shaft, comprising:
an input shaft disposed in parallel to the pump shaft, having one side in an axial direction forming an input portion for operatively inputting the rotational power from a drive source and the other side in the axial direction extending to the other side in the axial direction from an HST pump of the HST;
an output shaft disposed in parallel to the motor shaft and having one side in the axial direction forming an input portion for operatively inputting an HST output from the motor shaft and the other side in the axial direction forming an output portion;
an HST-input gear train for transmitting a rotational power from a part located on the other side in the axial direction from the HST pump in the input shaft to a corresponding part in the axial direction of the pump shaft;
an HST-output gear train for transmitting the rotational power to the input portion of the output shaft from a part located on the other side in the axial direction from an HST motor of the HST in the motor shaft; and
a housing having an HST housing space for housing the HST pump and the HST motor and a gear housing space for housing the HST-input gear train and the HST-output gear train, wherein
the input shaft extends into the HST housing space and the gear housing space, one side in the axial direction acting as the input portion is supported by the housing rotatably around an axis in a state where one side in the axial direction acting as the input portion is accessible from the one side in the axial direction of the housing and the other side in the axial direction is accessible from the other side in the axial direction of the housing;
the pump shaft and the motor shaft are supported by the housing rotatably around the axes in a state where the pump shaft and the motor shaft extend into the HST housing space and the other sides in the axial direction protrude into the gear housing space;
the output shaft is supported by the housing rotatably around the axis in a state where the other side in the axial direction acting as the output portion is accessible from the other side in the axial direction of the housing; and
the HST-input gear train and the HST-output gear train are housed in the gear housing space in a state where they overlap at least partially in the axial direction.

9. The HST unit according to claim 8, wherein the HST-input gear train includes an HST-input drive gear supported by the input shaft, incapable of relative rotation around an axis, and an HST-input driven gear meshed with the HST-input drive gear in a state of being supported by the pump shaft, incapable of relative rotation around the axis; and
the HST-output gear train includes an HST-output drive gear supported by the motor shaft, incapable of relative rotation, and an HST-output driven gear meshed with the HST-output drive gear in a state of being supported by the output shaft, incapable of relative rotation around the axis.

10. The HST unit according to claim 8, wherein the housing includes an HST case that forms the HST housing space and a gear case that forms the gear housing space and is detachably connected to the HST case
the input shaft is supported by the HST case and the gear case rotatably around an axis in a state where one side in an axial direction extends outward from the HST case and the other side in the axial direction extends outward from the gear case;
the pump shaft and the motor shaft are supported by the HST case rotatably around axes in a state where the other sides in the axial direction protrude into the gear housing space from the HST case; and
the output shaft is supported by the gear case rotatably around the axis in a state where the other side in the axial direction acting as the output portion extends outward from the gear case.
